(19) United States
(12) Patent Application Publication
(10) Pub. No.: US 2015/0225256 A1
(43) Pub. Date: Aug. 13, 2015

(54) WATER RECLAMATION SYSTEM AND METHOD

(71) Applicant: Neldon P. Johnson, Deseret, UT (US)

(72) Inventor: Neldon P. Johnson, Deseret, UT (US)

(21) Appl. No.: 14/179,343

(22) Filed: Feb. 12, 2014

(51) Int. Cl. C02F 1/06; C02F 1/14; B01D 1/00; B01D 1/20

(52) U.S. Cl. CPC C02F 1/06; B01D 1/20; C02F 1/14; B01D 1/0047; C02F 2103/08

(57) ABSTRACT

A water reclamation system and method incorporating a solar collector or other energy source, an energy source heat transfer element, a primary heat exchanger, a bladeless turbine, a collection chamber, a reclaimed water condenser, and a sludge scraper assembly. One or more pumps, control valves or other flow control devices may provide pressurization and control the flow of unheated transfer fluid, heated transfer fluid, raw water, and heated raw water. Embodiments vary from highly automated embodiments which incorporate an intricate system of sensors, control valves, pumps, and other components connected to and controlled by a control module which uses a complex algorithm to continuously and autonomously monitor and control the operation of all system components, to a totally manual system with no sensors, no automated components, and no control module.

### BACKGROUND OF THE INVENTION

This invention is in the field of systems and methods for the reclamation of water and in particular in the field of systems and methods for the removal of dissolved and suspended impurities from water through the use of a bladeless turbine.

In many settings and geographical areas, a scarcity of water, and, in particular, a scarcity of potable water, results in the consideration of many alternatives for the reclamation of water. Reclamation of brackish water or seawater, i.e. water containing a high concentration of dissolved solids or suspended solids, or both, is highly desirable in many geographical locations. Dissolved solids and suspended solids may be organic or inorganic. Also, the removal of dissolved or suspended solids from water is also highly desirable or even necessary prior to disposal or discharge of the water in a number of circumstances, such as waste water from oil wells and gas wells. There is also a need for systems and methods for the removal of dissolved and suspended solids from water in remote settings where there may be limited or no availability to electric power or other conventional sources of energy for use in the water reclamation process.

There are a number of technologies available, including widely used technologies, for the removal of dissolved and suspended solids from water. Most of these technologies are very expensive, complex, and energy intensive. Well known examples are reverse osmosis and distillation, which have a high cost per unit volume of water treated. Further, they require extensive and costly pretreatment for water containing a high concentration of suspended solids.

It is an objective of the present invention to provide a system and a method for the removal of dissolved and suspended solids from water that has a high concentration of dissolved solids or suspended solids or both.

It is a further objective of the present invention to provide a system and a method for the removal of dissolved and suspended solids from water that is comparatively simple to operate and maintain.

It is a further objective of the present invention to provide a system and a method for the removal of dissolved and suspended solids from water that is self powered.

It is a further objective of the present invention to provide a system and a method for the removal of dissolved and suspended solids from water that is economical to construct, operate, and maintain.

It is a further objective of the present invention to provide a system and a method for the removal of dissolved and suspended solids from water that is adaptable to installation and operation in remote locations.

### SUMMARY OF THE INVENTION

The present invention is a water reclamation system and a method. Unless the water to be reclaimed, which may be referred to in this application as “raw water”, is naturally heated, such as water from a geothermal well, or has been heated in an upstream process, such as a manufacturing process, an energy source is required for the system and the method of the present invention. The energy source may comprise a solar collector for providing heat to an unheated transfer fluid which flows to the energy source from a primary heat exchanger. Incident solar radiation may be focused by the solar collector onto a solar receiver which may serve as the energy source heat transfer element to transfer the energy received from the incident solar radiation to the unheated transfer fluid. Heated transfer fluid flows back from the energy source to the primary heat exchanger. Raw water flowing to the primary heat exchanger may then be heated by the primary heat exchanger, and the resultant heated raw water may be directed to the bladeless turbine which is enclosed in a collection chamber of the collection assembly.

One or more pumps, control valves or other flow control devices may be incorporated in the water reclamation system for providing pressurization and controlling the flow of the unheated transfer fluid, the heated transfer fluid, the raw water, and the heated raw water, to the extent needed for desired flow conditions for these fluids. Control of the temperature and pressure of the heated raw water within operating parameters at the turbine nozzles may be necessary for the proper and efficient operation of the bladeless turbine, including the complete flashing of the heated raw water at or near the turbine nozzles and the resultant separation of the dissolved and suspended solids from the heated raw water. Flow rate sensors, temperature sensors, pressure sensors, pumps, control valves, compressors, blowers, and other monitoring and control devices for the monitoring and control of flow, temperature, and pressure of the fluids of the system may be incorporated. A preferred embodiment of the bladeless turbine to be used for the present invention is the bladeless fluid turbine disclosed in U.S. Pat. No. 6,997,674 and U.S. Pat. No. 7,314,347, issued to the present inventor.

The heated raw water flows into the collection chamber to the bladeless turbine through the tubular bladeless turbine shaft, which is the turbine heated raw water inlet for the bladeless turbine. The heated raw water is directed through the turbine arms to the turbine nozzles. The heated raw water flashes to steam at or about the point of discharge of the heated raw water from the turbine nozzles to the collection chamber at ambient or near ambient pressure. The mass flow of the heated raw water causes the turbine arms and the bladeless turbine shaft of the bladeless turbine to rotate as provided for the normal operation of the bladeless turbine. As the heated raw water is flashed to steam, the dissolved solids and suspended solids contained in the heated raw water are separated from the water and are sprayed onto and deposited on the collection surface of the collection chamber as sludge. The sludge may have a variable moisture content.

A sludge scraper assembly having a sludge scraper with a pair of scraper arms and a pair of scraper blades scrapes the sludge from the collection surface and pushes the sludge to the auger channel where the sludge auger augers the sludge along the auger channel to the sludge discharge pipe. The sludge auger may extend into the sludge discharge pipe and may propel the sludge in the sludge discharge pipe to appropriate sludge handling facilities, which may be sludge drying beds.

For a preferred embodiment, the energy takeoff from the turbine shaft rotation may be used to power a generator, with surplus power generated during daylight hours stored in a battery system of other energy storage systems, for use during non-daylight hours for the continued production of reclaimed water. It is also anticipated that aside from supplying the power needs for the components of the water reclamation system, that there will typically be considerable surplus energy generated by the bladeless turbine which may be used for other purposes. The use of a solar collector for the energy source is preferred for the water reclamation system and the method of the present invention.

A simplified embodiment of the water reclamation system of the present invention provides for the raw water to be fed directly to the energy source for the production of the heated raw water, eliminating a heat exchange step. For a simplified embodiment using a solar collector as the energy source, the raw water is fed directly to the solar receiver and the heated raw water is produced by the direct transfer of heat from the solar receiver to the raw water.

Steam may be vented or propelled from the collection chamber by one or more collection chamber steam outlets and directed to the reclaimed water condenser for condensation of the reclaimed water. The reclaimed water normally will be very high quality with very low concentrations of dissolved solids and suspended solids. Further, due to the high temperature involved in heating and flashing of the heated raw water to steam, the reclaimed water may also be of high biological quality, free of pathogens.

The raw water flow rate and the raw water pressure of the raw water as supplied to the primary heat exchanger or the energy source, may be controlled as needed by one or more raw water control valves and raw water pumps. One or more raw water sensors may be connected to the raw water conduit for monitoring any or all of raw water flow rate, raw water pressure, raw water temperature, raw water dissolved solids concentration, raw water suspended solids concentration, or other conditions of the raw water as needed for the proper operation of the water reclamation system. A control module may control the operation of the raw water control valves and the raw water pumps. The rate at which the raw water may be processed to produce reclaimed water may depend on the incident solar radiation conditions, such as time of day and cloud cover, or the amount of stored energy remaining in a battery or other energy storage system storing energy derived from the energy takeoff. The temperature and pressure conditions of the heated raw water at the bladeless turbine nozzles may have to be maintained within operating ranges to provide for the proper flashing of the heated raw water by the turbine nozzles. For preferred embodiments, all of the heated raw water will be flashed to steam, which will facilitate maintaining a lower moisture content in the sludge.

Preferred embodiments of the water reclamation system of the present invention may incorporate varying levels of automation from a highly automated system which may use an intricate system of sensors, control valves, pumps, and other components connected to a central control module which may use a complex algorithm to continuously and autonomously monitor and control the operation of all system components, to a totally manual system with no sensors, no automated components, and no control module.

### BRIEF DESCRIPTION OF THE DRAWINGS

FIG. 1 is a flow diagram of a preferred embodiment of the water reclamation system and method of the present invention.

FIG. 2 is a schematic diagram of a preferred embodiment of the water reclamation system and method of the present invention.

FIG. 3 is a perspective cross section of a preferred embodiment of the water reclamation system of the present invention.

FIG. 4 is a plan view horizontal cross section of a preferred embodiment of the water reclamation system of the present invention.

FIG. 5 is a front view vertical view cross section of the collection chamber of a preferred embodiment of the water reclamation system of the present invention.

FIG. 6 is a side view vertical cross section of a preferred embodiment of the water reclamation system of the present invention.

FIG. 7 is a detail of a rear plate joint detail of an optional rear plate joint of a preferred embodiment of the water reclamation system of the present invention.

FIG. 8 is a detail of an optional rear plate joint and rear plate joint bracket of a preferred embodiment of the water reclamation system of the present invention.

FIG. 9 is a front view detail of a scraper blade insert assembly for a preferred embodiment of the water reclamation system of the present invention.

FIG. 10 is a flow diagram of a simplified preferred embodiment of the water reclamation system and method of the present invention.

FIG. 11 is a schematic diagram of a simplified preferred embodiment of the water reclamation system and method of the present invention.

FIG. 12 is a schematic detail of a section of a raw water conduit of a preferred embodiment of the present invention illustrating the use of a raw water pump and a raw water control valve for controlling the flow of raw water to the water reclamation system of the present invention.

### DETAILED DESCRIPTION OF PREFERRED EMBODIMENTS

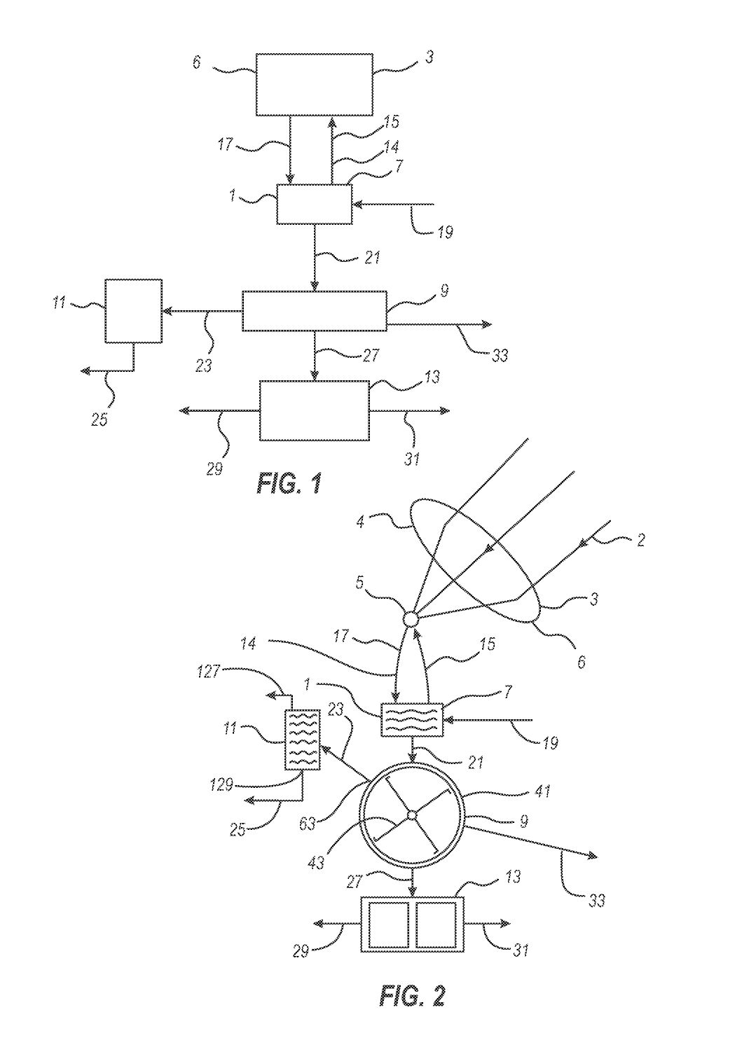

Referring first to FIG. 1, a flow diagram of a preferred embodiment of the water reclamation system 1 of the present invention is shown. Unless the water to be reclaimed is naturally heated, such as water from a geothermal well, or has been heated in an upstream process, such as a manufacturing process, an energy source 3 is required for the system and the method of the present invention. Referring also to FIG. 2, for a preferred embodiment of the water reclamation system 1 of the present invention, the energy source 3 may comprise a solar collector 6 for providing heat to an unheated transfer fluid 15 which flows to energy source 3 from a primary heat exchanger 7. The energy source 3 will have a transfer fluid inlet, an energy source heat transfer element for transferring heat produced by the energy source 3 to the unheated transfer fluid 15, and a heated transfer fluid outlet. The primary heat exchanger 7 may typically have a raw water inlet, a heated raw water outlet, a heated transfer fluid inlet, and a transfer fluid outlet. Heated transfer fluid 17 flows back from the energy source 3 to the primary heat exchanger 7. For the preferred embodiment shown in FIG. 2, incident solar radiation 2 may be focused by a solar collector 4 onto a solar receiver 5 which may serve as the energy source heat transfer element to transfer the energy received from the incident solar radiation 2 to the unheated transfer fluid 15. Raw water 19 flowing to the primary heat exchanger 7 may then be heated by the primary heat exchanger 7, and the resultant heated raw water 21 may be directed to the bladeless turbine 43 which is enclosed in the collection chamber 41 of the collection assembly 44.

It should be noted that one or more pumps, control valves or other flow control devices may be incorporated in the water reclamation system 1 for providing pressurization and controlling the flow of the unheated transfer fluid 15, the heated transfer fluid 17, the raw water 19, and the heated raw water 21, to the extent needed for desired flow conditions for these fluids. Control of the temperature and pressure of the heated raw water 21 within operating parameters at the turbine nozzles 47 may be necessary for the proper and efficient operation of the bladeless turbine 43, including the complete flashing of the heated raw water at or near the turbine nozzles 47 and the resultant separation of the dissolved and suspended solids from the heated raw water 21. The use of flow rate sensors, temperature sensors, pressure sensors, pumps, control valves, compressors, blowers, and other monitoring and control devices for the monitoring and control of flow, temperature, and pressure of fluids is well known to persons of skill in the art.

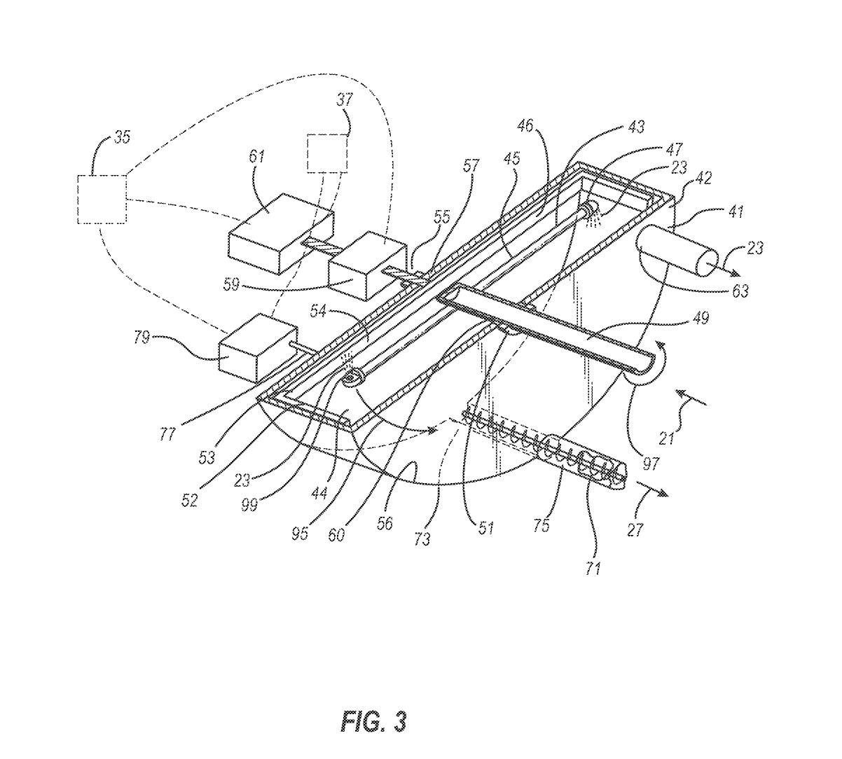

Referring also to FIG. 3, a preferred embodiment of the bladeless turbine 43 to be used for the present invention is the bladeless fluid turbine disclosed in U.S. Pat. No. 6,997,674 and U.S. Pat. No. 7,314,347, issued to the present inventor. For the embodiment of the present invention shown in FIGS. 3-6, the heated raw water 21 flows into the collection chamber 41 to the bladeless turbine 43 through the tubular bladeless turbine shaft 49, which is the turbine heated raw water inlet for the embodiment of the bladeless turbine 43 shown. The heated raw water 21 is directed through the turbine arms 45 to the turbine nozzles 47. The heated raw water 21 flashes to steam 23 at or about the point of discharge 99 of the heated raw water 21 from the turbine nozzles 47 to the collection chamber 41 at ambient or near ambient pressure. The mass flow of the heated raw water 21 causes the turbine arms 45 and the bladeless turbine shaft 49 of the bladeless turbine 43 to rotate as provided for the normal operation of the bladeless turbine 43, as disclosed in U.S. Pat. No. 6,997,674 and U.S. Pat. No. 7,314,347. As the heated raw water 21 is flashed to steam 23, the dissolved solids and suspended solids contained in the heated raw water 21 are separated from the water and are sprayed onto and deposited on the collection surface 56 of the collection chamber 41 as sludge 81. The moisture content of the sludge 81 may vary depending on the efficiency of the flashing of the heated raw water 21 to steam 23, the efficiency of the discharge of the steam 23 from the collection chamber 41, the configuration of the collection chamber 41, the temperature in the collection chamber 41, the characteristics of the solids in the sludge 81, and other variables.

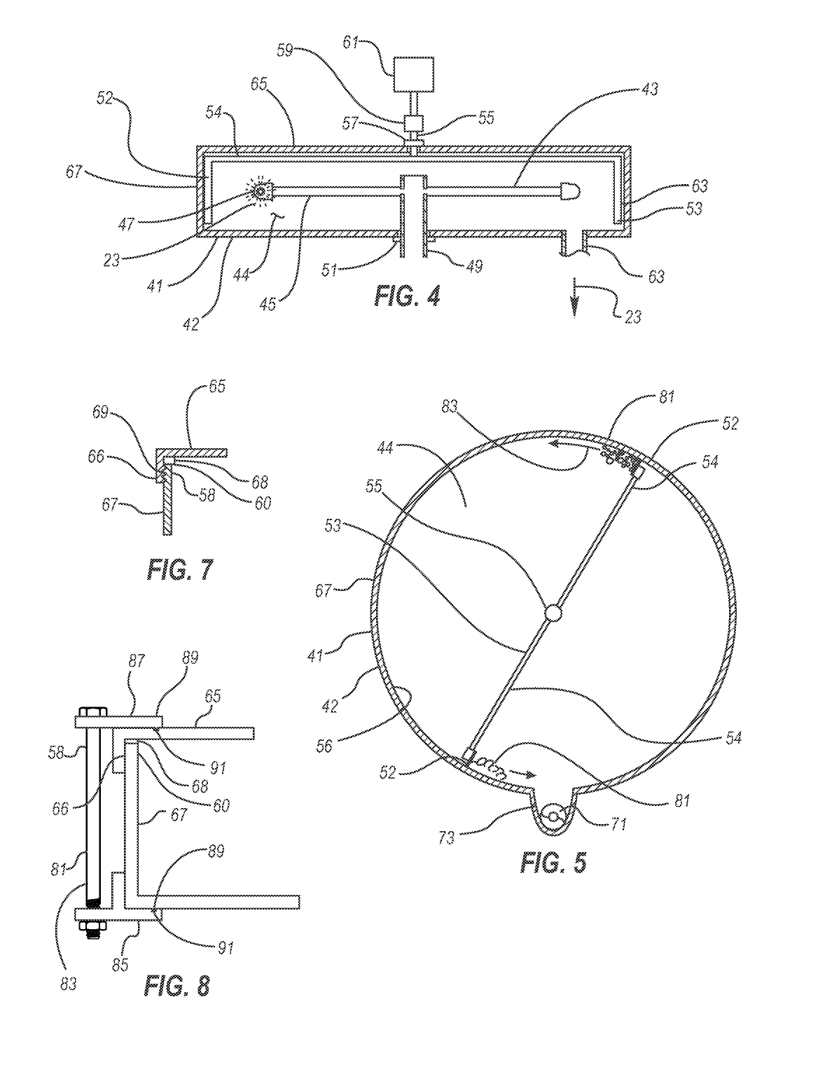

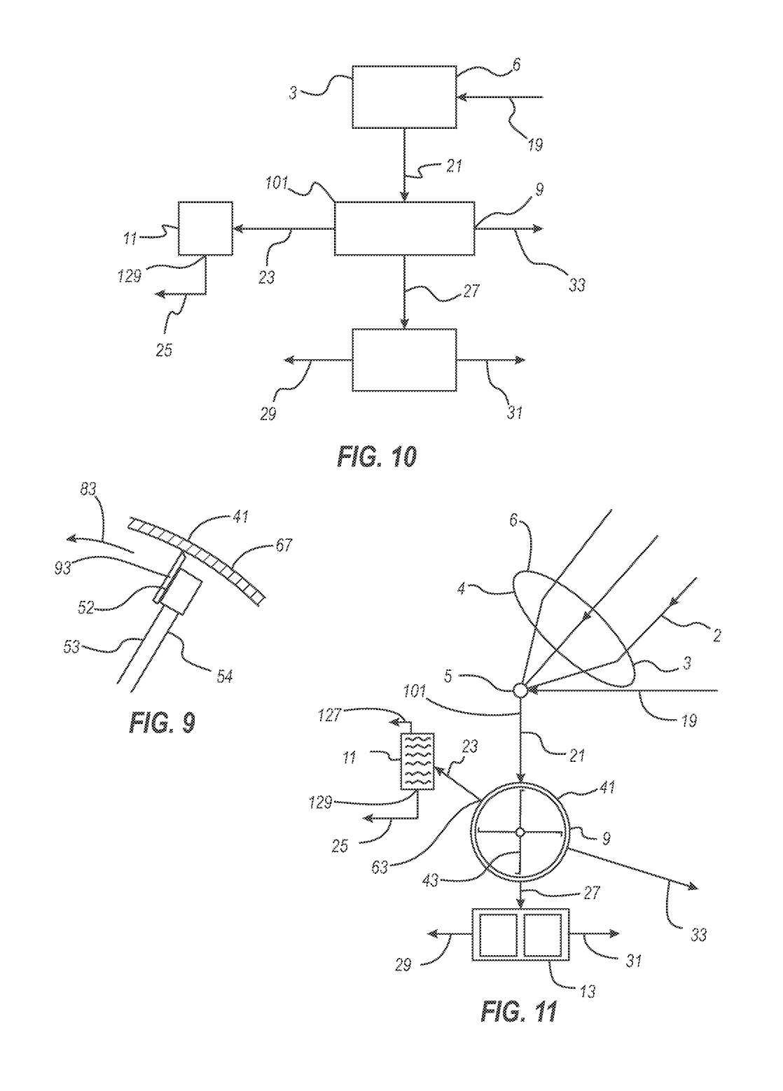

A sludge scraper assembly 46 having a sludge scraper 53 with a pair of scraper arms 54 and a pair of scraper blades 52, as shown in FIG. 4 and FIG. 5, is blade rotated 95 causing the scraper blades 52, with blade insert 93 as shown in FIG. 9, to scrape the sludge 81 from the collection surface 56 and to push the sludge 81 to the auger channel 73 where the sludge auger 71 augers the sludge 81 along the auger channel to the sludge discharge pipe 75. For alternative embodiments, the sludge scraper 53 may have one or more scraper arms 54. For the preferred embodiment of the water reclamation system 1 shown in FIG. 4 and FIG. 5, the sludge auger 71 may extend into the sludge discharge pipe 75 and may propel the sludge 81 in the sludge discharge pipe 75 to appropriate sludge handling facilities 13, which may be sludge drying beds such as illustrated in FIG. 2.

In view of this specification and the drawings, other variations of the collection chamber 41, collection assembly 44, and scraper assembly 46 will be known to persons of skill in the art. Further, other sludge extraction assemblies for aggregating and discharging sludge 81 deposited in the collection chamber 41 by the bladeless turbine 43 and scraped from the collection chamber 41 by the scraper assembly 46 will be known to persons of skill in the art in view of the disclosures of specification and drawings of this application. Further, other sludge scraping, sludge handling, sludge de-watering, and sludge disposal methods, devices and systems for use with the water reclamation system 1 of the present invention will be known to persons of skill in the art in view of the disclosures of the specification and drawings of this application. Any sludge supernatant 29 from the sludge handling facilities 13 may require further treatment or disposal considerations. Likewise, disposal of de-watered solids or other waste solids 31 from the sludge handling facilities may also require further treatment or disposal considerations.

The sludge scraper assembly 46 may incorporate a scraper motor 61 for the sludge scraper 53 with scraping speed controlled by scraper gear box 59 which are connected to the scraper by scraper shaft 55. A scraper seal and bearing assembly 57 provide for maintaining the proper positioning of the sludge scraper 53 and prevent the escape of steam from the collection chamber 41 of the collection assembly 44. A turbine bearing and seal assembly 51 provides for the rapid turbine shaft rotation 97 of the turbine shaft 49 and the turbine arms 45 and for sealing around the turbine shaft to prevent steam leakage from the collection chamber 41.

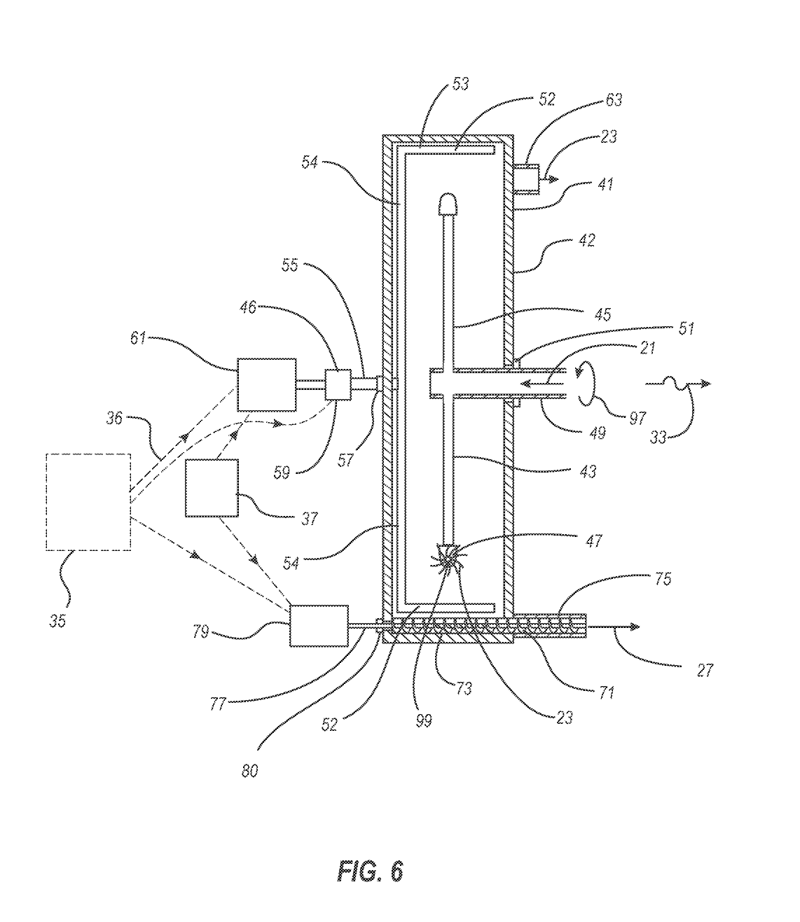

Referring to FIG. 6 the rotation of the sludge auger 71 may be provided by the sludge auger motor 79 connected to the sludge auger by auger shaft 77. The auger bearing and seal assembly 80 provide for the rotation and bearing of the auger shaft as it passes through the chamber wall 42 and for the prevention of steam or water leakage. A power supply 37 may be provided to the scraper motor 61 and the sludge auger motor 79. For a preferred embodiment, the power supply 37 may be energized by a generator and battery system which are powered by energy take off 33 from the turbine shaft rotation 97 of the turbine shaft 49. Generator and batteries and other energy storage systems that may be powered by energy take off from a turbine shaft of a turbine such as the bladeless turbine 43 incorporated in the water reclamation system 1 of the present invention, as well as power supplies that power motors from energy generated and stored in batteries or other storage devices, are well known to persons of skill in the art. Alternatives for the power supply 37 would be connection to a power grid with the power generated through energy take off 33 from the bladeless turbine 43 being synched to the grid. The use of generators, inverters, batteries, capacitors, transformers and switching circuits are well known to persons of skill in the art.

The control and operation of the scraper motor 61, scraper gear box 59, and sludge auger motor 79 may be provided by sludge control signals 36 from a control module 35 as shown on FIG. 6.

Referring now to FIG. 7 a detail showing a possible rear plate joint assembly 58 having a rear plate joint 60 which allows for the removal of the chamber rear plate 65 as needed for the service or maintenance of the bladeless turbine 43 or the sludge scraper 53. This embodiment of the rear plate joint assembly 58 provides for the chamber rear plate 65 to have a rear end plate 66 lapped over the chamber end plate 67. For the embodiment shown in FIG. 7, the rear end plate 66 is threaded on the chamber end plate 67 in a threaded joint 69. A rear joint plate seal 68 provides for the prevention of steam leakage from the rear plate joint assembly 58.

Referring now to FIG. 8, an alternative embodiment of a rear plate joint assembly 58 is shown. For this embodiment the rear end plate 66 laps over the chamber end plate 67 with rear plate joint seal 68 sealing the rear plate joint 60 against leakage. The rear plate bracket assembly 81, comprising a plurality of rear plate brackets 82 spaced around the perimeter of the collection chamber 41, may be used to hold the rear plate in the rear chamber plate 65 in position and maintain the seal provided by the rear plate joint seal 68. The rear plate brackets 82 each may consist of a first bracket end 85 and a second bracket end 87 which are securely positioned by a pair of bracket protrusions 89 which are mated with bracket recesses 91 and are bound together by bracket bolt 83.

Referring now to FIG. 10, a simplified embodiment of the water reclamation system 101 of the present invention is shown. Referring also to FIG. 11, the simplified embodiment of the water reclamation system 101 utilizing a solar collector 6 for the energy source 3 is shown. For this simplified embodiment, the raw water 19 is fed directly to the energy source 3 for the production of the heated raw water 21. For the preferred embodiment of the simplified water reclamation system 101 shown in FIG. 11, the raw water 19 is fed directly to the solar receiver 5 and the heated raw water 21 is produced by the direct transfer of heat from the solar receiver 5 to the raw water 19. Except for the simplification of feeding the raw water 19 directly to the energy source 3, which will preferably be the solar collector 6 as shown in FIG. 11, the embodiment shown in FIG. 10 may be the same as the embodiment shown in FIG. 1 and the embodiment shown in FIG. 11 may be the same as that shown in FIG. 2, the only difference being the elimination of a heat exchange step.

Depending on the quality of the raw water 19 some pre-treatment of the raw water 19 may be required to prevent clogging of the primary heat exchanger 7 for the embodiments shown in FIG. 1 and FIG. 2 or for the clogging of the bladeless turbine nozzles 47. This, however, will usually only involve course screening of the water in cases where there may be the risk of large suspended solids in the raw water.

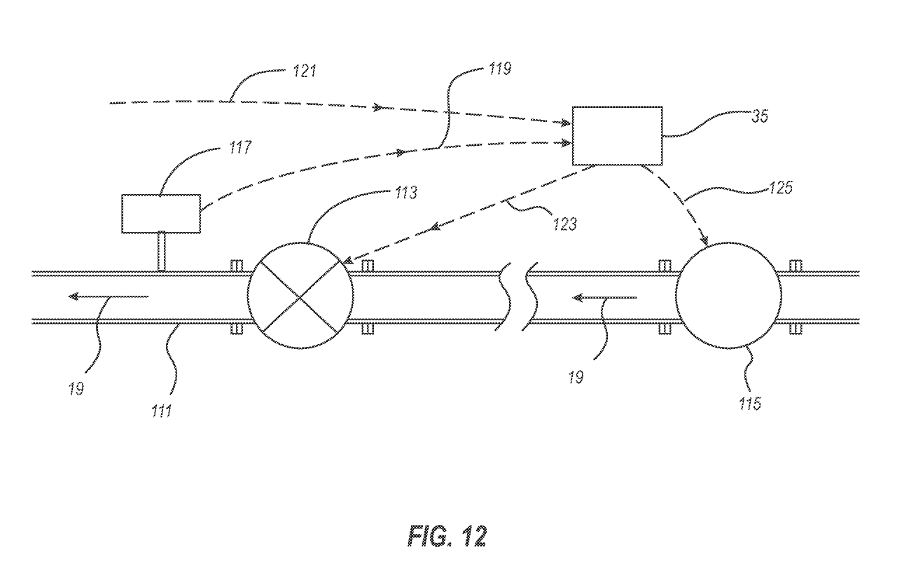

For remote application sites not having access to alternative energy sources or to a power grid, as well as for cost and energy conservation concerns, the use of a solar collector 6 for the energy source 3 as shown in FIG. 2 and FIG. 11 is preferred for the water reclamation system 1 and the method of the present invention. As stated above, the energy takeoff 33 from the turbine shaft rotation 97 may be used to power a generator, with surplus power generated during daylight hours stored in a battery system of other energy storage systems, for use during non-daylight hours for the continued production of reclaimed water 25. It is also anticipated that aside from supplying the power needs for the scraper motor 61, the sludge auger motor 79, the primary heat exchanger 7, the reclaimed water condenser 11, the control module 35, control valves, such as a raw water control valve 113 as shown in FIG. 12, pumps, such as the raw water pump 115 shown in FIG. 12, and other incidental components, that there will typically be considerable surplus energy generated by the bladeless turbine which may be used for other purposes.

Steam 23 may be vented or propelled from the collection chamber 41 by one or more collection chamber steam outlets 63 and directed to the reclaimed water condenser 11 for condensation of the reclaimed water 25. The reclaimed water 25 normally will be very high quality with a very low total dissolved solids concentration and a very low suspended solids concentration. Further, due to the high temperature involved in heating and flashing of the heated raw water 21 to steam 23, the reclaimed water 25 normally will be of high biological quality, free of pathogens. Monitoring of biological quality, however, will ordinarily be required due to the relatively short duration of the high temperature of the water and steam. Heat extracted from the steam 23 by the reclaimed water condenser 11 may be re-circulated to the primary heat exchanger 7 or directly to the raw water 19. A number of types of devices and mechanisms for use as the reclaimed water condenser 11 will be known to persons of skill in the art.

Referring to FIG. 12, the raw water 19 may be supplied to the primary heat exchanger 7 for embodiments of the water reclamation system 1 shown in FIG. 1 and FIG. 2, or directly to the energy source 3 as shown in FIG. 10 and FIG. 11 by a raw water conduit 111. The raw water flow rate and the raw water pressure of the raw water 19 as supplied to the primary heat exchanger 7 or the energy source 3, may be controlled as needed by one or more raw water control valves 113. Also, depending on the source of the raw water 19, one or more raw water pumps 115 may be used to, together with one or more raw water control valves 115 to maintain a desired raw water flow rate and a desired raw water pressure to the primary heat exchanger 7 or the energy source 3. One or more raw water sensors 117 may be connected to the raw water conduit 111 for monitoring any or all of raw water flow rate, raw water pressure, raw water temperature, raw water dissolved solids concentration, raw water suspended solids concentration, or other conditions of the raw water as needed for the proper operation of the water reclamation system 1. The control module 35 may control the operation of the raw water control valves 113 by raw water control valve signals 123 and the raw water pumps 115 by raw water pump control signals 125, based upon raw water data signals 119 from the raw water sensors 117, in order to provide the raw water 19 to the primary heat exchanger 7 or the energy source 3 at a desired flow rate and pressure. The control module 35 may also utilize component sensor data 121 from other components of the water reclamation system 1 in generating the raw water control valve signals 123 and the raw water pump signals 125. For example, for embodiments of the water reclamation system 1 having a solar collector 4 for the energy source 3, the rate at which the raw water 19 may be processed to produce reclaimed water 25 may depend on the incident solar radiation 2 conditions, such as time of day and cloud cover, or the amount of stored energy remaining in a battery or other energy storage system storing energy derived from the energy takeoff 33. As a further example, the temperature of the heated transfer fluid 15 may be monitored and used by the control module in the control of the raw water control valves 113 or the raw water pumps 115, or both. As indicated above, the temperature and pressure conditions of the heated raw water 21 at the bladeless turbine nozzles 47 may have to be maintained within operating ranges to provide for the proper flashing of the heated raw water by the turbine nozzles 47. The required operating ranges for the heated raw water temperature and pressure may depend, for example, on the internal diameter of the turbine nozzles 47. Preferred embodiments may provide for flashing of all of the heated raw water 21 to steam 23, which may facilitate minimizing the moisture content of the sludge 81 deposited in the collection chamber 41 and aggregated to the sludge extraction assembly.

For the embodiments of the water reclamation shown in FIG. 1 and FIG. 2, the flow rate and pressure of the transfer fluid of the transfer fluid recirculation system 14 may be monitored and controlled. Depending on the transfer fluid 15 used and its thermal and physical characteristics, the flow rate and pressure may be controlled to prevent vaporization of the heated transfer fluid 17 while providing for the required heating of the raw water 19 by the primary heat exchanger 7 to produce heated raw water 21 with a temperature in a required operating range. One or more transfer fluid sensors, one or more transfer fluid control valves, and one or more transfer fluid pumps may be incorporated in the transfer fluid recirculation system 14 with the transfer fluid control valves and the transfer fluid pumps controlled by the control module 35 to produce a desired transfer fluid flow rate, while maintaining transfer fluid pressure within a desired operating range, based upon transfer fluid temperature, heated transfer fluid temperature, desired heated raw water temperature, raw water flow rate, raw water temperature, heated raw water temperature, and other component sensor data 121.

For the preferred embodiments of the water reclamation system 1 shown in FIG. 1, FIG. 2, FIG. 3, and FIG. 4, heated raw water temperature sensors and heated raw water pressure sensors may be used to provide heated raw water temperature data and heated raw water pressure data to the control module 35 on a continuous or intermittent basis. As stated above, maintaining the heated raw water 21 temperature and pressure within desired operating ranges may be required for the effective flashing of the heated raw water 21 by the turbine nozzles 47, and thus the effective and efficient removal of solids from the heated raw water by the collection assembly 44. Accordingly, the control module 35 may cause raw water control valves 113 or raw water pumps 115, or both, to adjust the raw water flow rate or the raw water pressure or both, and, for the embodiments shown in FIG. 1 and FIG. 2, may cause the transfer fluid flow rate to be adjusted.

Alternative embodiments of the water reclamation system 1 may provide for the use of a lower operating pressure for the primary heat exchanger 7. For such alternative embodiments, a heated raw water pump may be provided on a heated water conduit between the primary heat exchanger 7 and the bladeless turbine 43. This allows for a lower operating pressure for the raw water 19 as it flows to the primary heat exchanger 7, and for the heated raw water pressure to be increased after flowing through the primary heat exchanger 7 and prior to flowing to the bladeless turbine 43.

For the ordinary operation of preferred embodiments of the water reclamation system 1 of the present invention, the control module 35 may use sensor data to control the operation of system components so as to maximize the quantity of reclaimed water produced while providing for energy take off 33 from the bladeless turbine that provides for some or all of the energy requirements for the operation of the water reclamation system 1. Preferred embodiments using a solar collector 4 for the energy source 3, depending on the design of the solar collector 4, may produce a surplus of energy above that required for the operation of the water reclamation system 1 and the resultant production of reclaimed water 25.

It is anticipated that, for most preferred embodiments, the collection chamber 41 will be sealed against the leakage of steam, and that the production of steam 23 in the collection chamber 41 will result in pressurization of the collection chamber 41 that will be sufficient to cause the steam 23 to flow rapidly from the collection chamber 41 to the reclaimed water condenser 11. A collection chamber air inlet may be provided for the collection chamber 41 if needed for the proper flow of steam 23 from the collection chamber 41 to the reclaimed water condenser 11. A fan, blower or other means of propelling or suctioning the steam 23 from the collection chamber 41 to the reclaimed water condenser 11, may be incorporated if needed. Alternatively or additionally, one or more steam control valves may be incorporated between the collection chamber 41 and the reclaimed water condenser 11, in the reclaimed water condenser 11, or at the condenser vent 127, for controlling the pressure and flow of steam in the reclaimed water condenser 11. One or more reclaimed water control valves may also be incorporated on the reclaimed water outlets 129 of the reclaimed water condenser 11 for assisting in controlling the pressure and flow of the steam in the reclaimed water condenser 11. One or more steam temperature sensors and one or more steam pressure sensors may be incorporated for the collection chamber 41. Further, one or more steam temperature sensors, steam pressure sensors, and mass flow sensors may be incorporated between the collection chamber 41 and the reclaimed water condenser 11, or at the reclaimed water condenser 11 for providing component sensor data 121 to the control module 35 for use by the control module 35 in controlling the operation of steam control valves and reclaimed water control valves. This component sensor data 121 may also be used by the control module 35 to control the operation of other components of the water reclamation system 1.

One or more reclaimed water flow rate sensors, reclaimed water temperature sensors, reclaimed water pressure sensors, reclaimed water total dissolved solids sensors, and reclaimed water suspended solids sensors, may also be incorporated for the reclaimed water outlets 129, to provide component sensor data 121 to the control module 35 for use by the control module 35 in controlling the operation of steam control valves and reclaimed water control valves. This component sensor data 121 may also be used by the control module 35 to control the operation of other components of the water reclamation system 1.

Preferred embodiments of the water reclamation system 1 of the present invention may incorporate varying levels of automation from a highly automated system which may use an intricate system of sensors, control valves, pumps, and other components connected to a central control module 35 which may use a complex algorithm to continuously and autonomously monitor and control the operation of all system components, to a totally manual system with no sensors, no automated components, and no control module. Alternative preferred embodiments may incorporate independently operating component control modules, such as a raw water control module which may control the flow rate and pressure of the raw water 19, a primary heat transfer control module which may control the flow rate, pressure and temperature of the transfer fluid 15, or a heated raw water control module which may control the pressure and temperature of the heated raw water 21 flowing to the bladeless turbine 43. A totally manual system may be as simplistic as requiring only that an operator manually adjust the raw water flow rate or the transfer fluid flow rate based upon certain manually observed operating conditions, such as the nature of incident solar radiation 2 or the temperature and pressure of the heated raw water 21. The level of automation may be selected to match initial cost, operation and maintenance cost, operational complexity, or other constraints or objectives. So long as the temperature and pressure of the heated raw water 21 directed to the bladeless turbine 43 are controlled, either autonomously or manually, to be within the operating range that will provide for effective flashing of the heated raw water 21, and so long as the steam flow and operation of the reclaimed water condenser 11 are controlled, either autonomously or manually, to provide for effective condensation of the reclaimed water 25 from the steam 23, the primary purpose and objective of the water reclamation system 1 and the method of the present invention may be achieved.

In view of the disclosures of this specification and the drawings, various embodiments using varying levels of automation and instrumentation for monitoring and control of the components and the overall water reclamation system 1 will be known to persons of skill in the art. Also, in view of the disclosures of this specification and the drawings, the use of various conduits, pipes, valves, control valves, pumps, blowers, sensors, and other components known in the art, or developed hereafter, for the handling, conveying, controlling, pressurizing, and monitoring fluids and fluid flow for various embodiments of the water reclamation system 1 and the method of the present invention will be known to persons of skill in the art. Also, in view of the disclosures of this specification and the drawings, the use of various pipes, conduits and direct connections for hydraulically interconnecting the components of the water reclamation system will be known to persons of skill in the art.

Further, in view of the disclosures of this specification and the drawings, the use of various types of sensors not specifically identified in this specification will be known by persons of skill in the art, or may be developed hereafter, that may be utilized for the water reclamation system 1 and the method of the present invention for improved operation, capacity and efficiency.

Further, in view of the disclosures of this specification and the drawings, the use of various types of heat exchange devices for the primary heat exchanger 7 and the reclaimed water condenser 11 for various embodiments of the water reclamation system 1 and the method of the present invention will be known to persons of skill in the art. Further, in view of the disclosures of this specification and the drawings, the use of various types of solar collectors 4 for the energy source 3, and various types of solar receivers 5 providing for heat transfer to the transfer fluid 15 or the raw water 19 for various embodiments of the water reclamation system 1 and the method of the present invention will be known to persons of skill in the art.

In view of the disclosures of this specification and the drawings, other embodiments and other variations and modifications of the embodiments described above will be obvious to a person skilled in the art. Therefore, the foregoing is intended to be merely illustrative of the invention and the invention is limited only by the following claims and the doctrine of equivalents.

What is claimed is:

1. A water reclamation system for removing dissolved solids or suspended solids from raw water, the water reclamation system comprising:
an energy source having an energy source heat transfer element, an energy source transfer fluid inlet and an energy source heated transfer fluid outlet;
a primary heat exchanger having a transfer fluid outlet, a heated transfer fluid inlet, a heat exchanger raw water inlet and a heat exchanger heated raw water outlet;
a transfer fluid recirculation system hydraulically connecting the energy source and the primary heat exchanger;
a collection chamber having a collection chamber steam outlet, a collection chamber bottom, and a chamber sludge outlet;
a sludge scraper assembly having a sludge scraper positioned in the collection chamber, and a sludge scraper drive mechanism;
a sludge extraction assembly;
a bladeless turbine positioned in the collection chamber, the bladeless turbine having a turbine heated raw water inlet hydraulically connected to the heat exchanger heated raw water outlet; and
a reclaimed water condenser hydraulically connected to the collection chamber steam outlet.

2. The water reclamation system recited in claim 1 wherein the collection chamber has an auger channel positioned proximal to the chamber bottom and wherein the sludge extraction assembly comprises a sludge auger positioned in the auger channel and a sludge auger drive mechanism.

3. The water reclamation system recited in claim 1 wherein the energy source is a solar collector.

4. The water reclamation system recited in claim 1 wherein the energy source heat transfer element is a solar receiver.

5. The water reclamation system recited in claim 1 further comprising one or more sensors.

6. The water reclamation system recited in claim 1 further comprising one or more flow control devices.

7. The water reclamation system recited in claim 1 further comprising a control module.

8. A water reclamation system for removing dissolved solids or suspended solids from raw water, the water reclamation system comprising:
an energy source having an energy source heat transfer mechanism, a raw water inlet and a heated raw water outlet;
a collection chamber having a collection chamber steam outlet, a collection chamber bottom, and a chamber sludge outlet;
a sludge scraper assembly having a sludge scraper positioned in the collection chamber, and a sludge scraper drive mechanism;
a sludge extraction assembly;
a bladeless turbine positioned in the collection chamber, the bladeless turbine having a turbine heated raw water inlet hydraulically connected to the energy source heated raw water outlet; and
a reclaimed water condenser hydraulically connected to the collection chamber steam outlet.

9. The water reclamation system recited in claim 8 wherein the collection chamber has an auger channel positioned proximal to the chamber bottom and wherein the sludge extraction assembly comprises a sludge auger positioned in the auger channel and a sludge auger drive mechanism.

10. The water reclamation system recited in claim 8 wherein the energy source is a solar collector.

11. The water reclamation system recited in claim 8 wherein the energy source heat transfer mechanism is a solar receiver.

12. The water reclamation system recited in claim 8 further comprising one or more sensors.

13. The water reclamation system recited in claim 8 further comprising one or more flow control devices.

14. The water reclamation system recited in claim 8 further comprising a control module.

15. A method for removing dissolved solids or suspended solids from raw water, the method comprising:
heating a transfer fluid with heat from an energy source to produce heated transfer fluid;
transferring the heat from the heated transfer fluid to the raw water to produce heated raw water;
supplying the heated raw water to a bladeless turbine enclosed in a collection chamber, the bladeless turbine having a plurality of turbine nozzles and each turbine nozzle having a nozzle exit, the heated raw water being supplied to the bladeless turbine at a heated raw water temperature and at a heated raw water pressure which provide for the heated raw water to be flashed to steam at or near the nozzle exits, solids from the heated raw water being deposited as sludge on a collection surface in the collection chamber;
condensing the steam to produce reclaimed water; and
extracting the sludge from the collection chamber.

16. The method for removing dissolved solids or suspended solids from raw water recited in claim 15 wherein the energy source is a solar collector.

17. A method for removing dissolved solids or suspended solids from raw water, the method comprising:
heating the raw water with heat from an energy source to produce heated raw water;
supplying the heated raw water to a bladeless turbine enclosed in a collection chamber, the bladeless turbine having a plurality of turbine nozzles and each turbine nozzle having a nozzle exit, the heated raw water being supplied to the bladeless turbine at a heated raw water temperature and at a heated raw water pressure which provide for the heated raw water to be flashed to steam at or near the nozzle exits, solids from the heated raw water being deposited as sludge on a collection surface in the collection chamber;
condensing the steam to produce reclaimed water; and
extracting the sludge from the collection chamber.

18. The method for removing dissolved solids or suspended solids from raw water recited in claim 17 wherein the energy source is a solar collector.
